(19) United States
(12) Patent Application Publication
(10) Pub. No.: US 2016/0280411 A1
(43) Pub. Date: Sep. 29, 2016

(54) LABEL APPLICATION APPARATUS FOR LABELLING MACHINE

(71) Applicant: SIDEL PARTICIPATIONS S.A.S., Octeville-sur-Mer (FR)

(72) Inventors: James CARMICHAEL, Parma (IT); Stefano CORRADINI, Parma (IT)

(21) Appl. No.: 15/064,636

(22) Filed: Mar. 9, 2016

(30) Foreign Application Priority Data
Mar. 23, 2015 (EP) 15160408.9

(51) Int. Cl. B65C 9/20; B65C 9/08

(52) U.S. Cl. CPC B65C 9/20; B65C 9/08; B65C 2009/0071

(57) ABSTRACT

A label application apparatus comprising: an input station, at which a succession of separate labels is formed; an application station, at which each of the labels is applied on a respective article advancing along an article path; a transfer drum configured to retain each label on an outer lateral surface of the transfer drum by suction and to rotate about an axis to transfer each of the labels from the input station to the application station along a label path; a glue applicator arranged peripherally with respect to the transfer drum between the input and application stations with reference to the label path; and a laser emitter arranged peripherally with respect to the transfer drum and configured to generate a laser beam towards the transfer drum to remove at least one of dirt or glue residues from the outer lateral surface of the transfer drum.

### TECHNICAL FIELD

The present invention relates to a label application apparatus for a labelling machine.

In particular, the present invention relates to an apparatus for applying labels of the type cut off a roll or labelling material at appropriate lengths, then fed with glue on their back sides and stuck onto the outer surfaces or articles—in particular receptacles, such as bottles, pots, cans or the like—travelling along an article path in a labelling machine.

### BACKGROUND ART

As known, according to a widespread technique, labels are attached on the external surfaces of respective articles by means of glue previously applied on the back surfaces of the labels themselves.

In particular, labels are cut from a web at appropriate lengths and then advanced by a transfer drum towards an application station, at which labels are applied onto the respective articles. Prior to reaching the application station, each label receives a given amount of melted glue on its back surface by a glue applicator, such as a rotatable glue roller, cooperating tangentially with the transfer drum, or spray or injector systems; in practice, as it is advanced by the transfer drum, each label receives, on the opposite side thereof with respect to the transfer drum, the melted glue by the glue applicator.

Label application apparatuses and, more in general, labelling machines for automatically performing these operations are well known in the art and their use is widespread in the packaging industry.

In these machines, the articles are typically carried by a carrousel along an article path so as to advance towards the application station. At the same time, in the known label application apparatuses, a web of labelling material is fed from a roll-feeding unit to the outer lateral surface of the transfer drum, whereby said web is brought into contact with cutting means to be cut into labels of appropriate length.

In particular, the labels are retained by respective retaining regions of the outer lateral surface of the transfer drum; these retaining regions are equally spaced angularly around the axis of the transfer drum and are separated from each other by respective transition regions, along which labels fed from the roll-feeding unit slide prior to reaching the respective retaining regions.

Subsequently, glue is applied by the glue applicator on the labels as they are borne by the retaining regions of the outer lateral surface of the transfer drum. Glued labels are finally transferred from the transfer drum to the articles.

For proper performance of these operations, accurate handling of the labels is pursued through transfer drum, i.e. by applying suction or vacuum on the labels in a controlled manner. To this purpose, the outer lateral surface of the transfer drum comprise a plurality of orifices that can be fiuidically connected with a suction source.

During application of glue on the labels, especially when such application is performed by cooperation of the transfer drum with a rotatable glue roller, airborne glue particles may contaminate the transition regions of the outer lateral surface of the transfer drum. This type of contamination may cause failure of the labelling process as friction and drag may hamper slipping of the labels on the transfer drum during feeding from the roll-feeding unit and also may cause distortion and/or breakage of the labels themselves.

### DISCLOSURE OF INVENTION

It is therefore an object of the present invention to provide a label application apparatus for a labelling machine, which is designed to overcome, in a straightforward and low-cost manner, the aforementioned drawback.

According to the present invention, there is provided a label application apparatus as claimed in claim 1.

### BRIEF DESCRIPTION OF THE DRAWINGS

Two non-limiting embodiments of the present invention will be described by way of example with reference to the accompanying drawings, in which:

FIG. 1 shows a top plan schematic view of a label application apparatus according to the present invention for applying a succession of labels onto the surface of articles advancing along an article path in a labelling machine;

FIG. 2 shows a larger-scale perspective view, with parts removed for clarity, of a label transfer drum. and a cleaning device of the FIG. 1 label application apparatus;

FIGS. 3 and 4 show larger-scale, fiat-developed section views of a part of the label transfer drum of FIG. 2, during two different, schematically-represented operative modes of the cleaning device;

FIGS. 5 and 6 show larger-scale front views of an outer lateral portion of the transfer drum of FIG. 2 during other two schematically-represented operative modes of the cleaning device;

FIGS. 7a and 7b show schematic lateral views of a detail of FIG. 2 in two different operative conditions of the cleaning device;

FIG. 8 is analogous to FIGS. 5 and 6 and shows the outer lateral portion of the transfer drum during a further schematically-represented operative mode of the cleaning device;

FIG. 9 shows a top plan schematic view of a label application apparatus according to a different embodiment of the present invention; and

FIG. 10 shows a larger-scale perspective view, with parts removed for clarity, of a label transfer drum and a cleaning device of the FIG. 9 application apparatus.

### BEST MODES FOR CARRYING OUT THE INVENTION

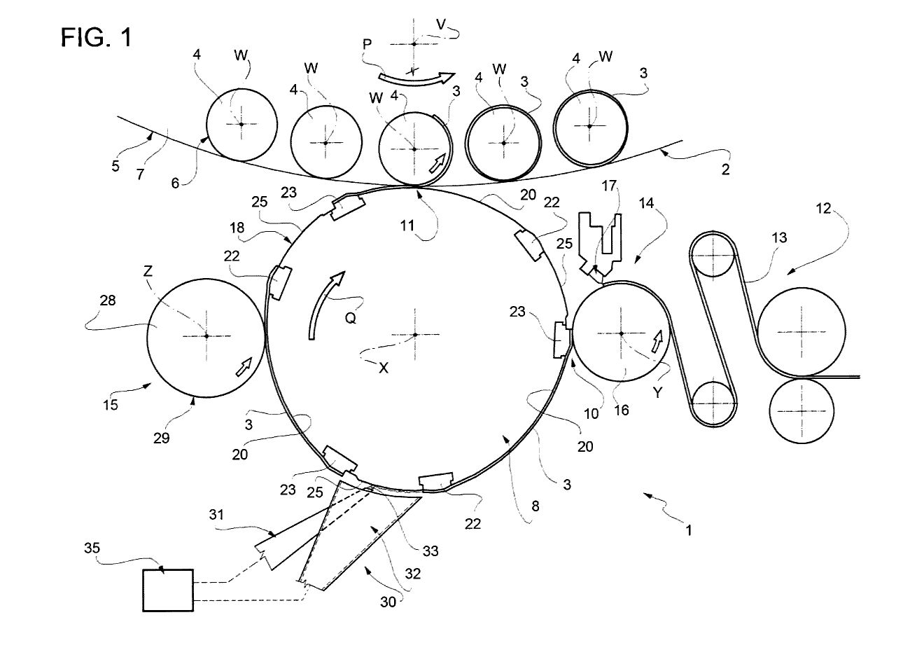

Number 1 in FIG. 1 indicates as a whole a label application apparatus for a labelling machine 2, only partially shown to the extent that is necessary for the comprehension of the present invention.

Apparatus 1 is adapted to be used for handling, transferring and applying labels 3 to respective articles 4 or, more specifically, receptacles, such as bottles, as said articles 4 are advanced by a carrousel 5 (known per se and only partially shown) of the labelling machine 2 along an article path P.

In particular, carrousel 5 comprises a plurality of support plates 6, which are equally spaced about a rotation axis V, are mounted along a peripheral edge 7 of the carrousel 5 itself and are moved by the latter along an annular path. Axis V preferably extends vertically and the article path P is defined by an arc-shaped portion of the annular path of the plates 6; as a matter of fact, article path F starts from an article feeding station (known per se and not shown) and ends at an article releasing station (also known per se and not shown), both stations being arranged along the annular path of the plates 6.

Each support plate 6 is rotatable about a respective axis W, parallel to the axis V of the carrousel 5, so that articles 4 may be rotated as they are advanced along the article path P.

Apparatus 1 basically comprises:

a label transfer drum 8 having an axis X, parallel to axes V and W, and rotating about its axis X to transfer a succession of labels 3 from an input station 10 to an application station 11 along a label path Q, tangential to article path P at the application station 11 itself;

a feeding unit 12 for feeding a web 13 of labelling material to the input station 10;

a cutting unit 14 of known type, arranged adjacent to input station 10 for cutting off the succession of labels 3 from the web 13 of labelling material; and

a glue applicator 15 arranged peripherally with respect to transfer drum 8 and between input and application station 10, 11 with reference to label path Q so as to apply a given amount of glue on the back, side of each label 3 advancing along the label path Q prior to reaching the application station 11.

In particular, the web 13 of labelling material is fed off a reel (not shown) and is separated into labels 3 by cutting unit 14. In this way, a succession of separate labels 3 is formed at input station 10.

More specifically, cutting unit 14 comprises:

a rotary cutting drum 16, having an axis Y parallel to axes V, W, X, arranged peripherally adjacent—preferably tangential—to transfer drum 8 at input station 10 and carrying, on its outer lateral surface, the web 13 of labelling material; and

a stationary cutter blade or cutter 17 carried in a fixed position on one side of rotary cutting drum 16 and proximal to input station 10 so as to cooperate in use with the rotary cutting drum 16 to cut one label 3 at a time from, the web 13 of labelling material.

In practice, labels 3 are obtained as lengths of labeling material of substantially rectangular shape which, are cut off the web 13 after the leading edge thereof is transferred from the rotary cutting drum 16 to the transfer drum 8 and the portion destined to define the trailing edge of the label 3 to be separated engages the stationary cutter 17.

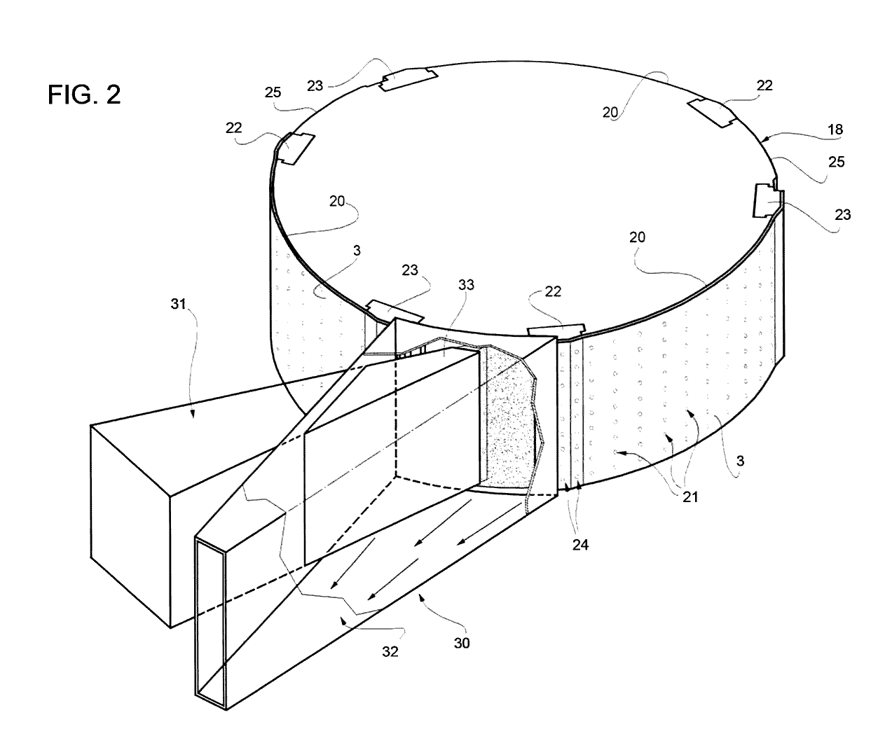

As visible in FIGS. 1 and 2, transfer drum 8 is configured to retain the labels 3 on its outer lateral, surface 18 by suction during its rotation about axis X; in this way, labels 3 are transferred by transfer drum 8 from the input station 10 to the application station 11, at which each label 3 is applied on a respective article 4 advancing along the article path P.

As visible in FIG. 1, application station 11 is arranged at a given angular distance from the input station 10 about the axis V of rotation of transfer drum 8.

With further reference to FIG. 2, outer lateral surface 18 of transfer drum 8 comprises one or more label retaining regions 20, three in the example shown, provided with a plurality of through holes 21 selectively communicating in a known manner with a suction or vacuum source (known per se and not shown) through internal passages (not visible) of the transfer drum 8 itself. In practice, these internal passages can be connected to the suction or vacuum source by means of suitable orifices or manifolds present on a non-rotating base (known per se and not shown) on which the transfer drum 8 is supported and rotated.

Retaining regions 20 are adapted to retain the respective labels 3 during transfer thereof from input station 10 to application station 11.

It is evident that a different number of retaining regions 20 can be provided on the outer lateral surface 18 of transfer drum 8, depending on the capacity of the apparatus 1 and the labelling machine 2 and on the length of the labels 3.

As shown in FIGS. 1 and 2, two pads 22, 23 are disposed at the two extremities of each retaining region 20 of outer lateral surface 18. These pads 22, 23 are slightly protruding from the outer lateral surface 18 and are designed to engage, in use, with the leading and the trailing ends of a label 3, respectively. To this purpose, the pads 22, 23 also present, a plurality of through holes 24 selectively communicating with the suction or vacuum source.

In practice, during transfer of a label 3 from the rotary cutting drum 16 to the transfer drum 8, progressive slide-back of the label 3 itself ensures that the label position at the point of cut corresponds to a specific position whereat, the leading edge of the label 3 is positioned on the downstream pad 22 and the trailing edge of the label 3 is positioned on the upstream pad 23.

The pads 22 and 23 also define the zones of the periphery of the transfer drum 8 where label transfer occurs from the relative retaining region 20 to the corresponding article 4.

Retaining regions 20 of outer lateral surface 18 are equally spaced angularly around axis X of transfer drum 8 and are separated from each other by respective transition regions 25, on which labels 3 fed from feeding unit 12 slide prior to reaching the respective retaining regions 20.

In practice, by considering the direction of rotation of transfer drum 8 (which direction is indicated in FIG. 1 by the hatched arrow and is clockwise), each transition region 25 extends between the back pad 23 of a downstream retaining region 20 and the front pad 22 of an upstream retaining region 20 and is provided with through holes 26, also selectively connectable with the suction or vacuum source.

In the embodiment illustrated in FIGS. 1 and 2, three transition regions 25 are present on the transfer drum 8, which are equally spaced angularly from one another about the axis X.

In other words, considering the direction of rotation of the transfer drum 8, each retaining region extends from, the rear edge of an upstream pad 23 to the front edge of a relative downstream pad 22, whilst the corresponding transition region 25 extends from this downstream pad 22 to the next pad 23.

As commented above with reference to the retaining regions 20, also the overall number of transition regions 25 provided in the outer lateral surface 18 of the transfer drum 8 can vary accordingly, depending on the capacity of the apparatus I and the labelling machine 2 and, even more so, on the length of the labels 3 to be processed, the minimum number being one.

As visible in the example of FIGS. 1 and 2, each transition region 25 has a smaller angular extension or width around axis X than the angular extension or width of the relative retaining region 20 and, in use, can serve the purpose of starting to attract the relative label 3 at input station 10, so that such label 3 is then received on the retaining region 20 directly upstream and on the relative pads 22, 23.

According to possible alternative solutions, each transition region 25 may also have the same angular extension around axis X as the relative retaining region 20 or even a larger angular extension than that of such retaining region 20, depending on the lengths of the labels 3 to be applied on the articles 4.

The transfer drum 8 works conventionally by rotating in the direction indicated by the hatched arrow in FIG. 1, so that it first receives, substantially at the input station 10, the web 13 of labelling material, which is then cut to obtain a label 3 of the desired length as it engages the stationary cutter 17.

More particularly, the web 13 first advances with the rotary cutting drum 16 and is secured, to the outer lateral surface thereof by suction. The suction is conveniently discontinued when the web 13 of labelling material reaches the input station 10, at which the leading edge of the web 13 can be picked by the transfer drum 8.

As it is transferred substantially at the input station 10, the labelling material is subject to a tension, created by the simultaneous supply of suction from both the transfer drum 8 and the rotary cutting drum 16. As the transfer progresses, the influence of the suction supplied at the rotary cutting drum 16 decreases, as the portion of labelling material retained by the transfer drum 3 increases. As a consequence, the web 13 comes to engage the stationary cutter 17.

At the cutting point, the cut label 3 is carried solely by the transfer drum 8. The completion of the transfer can be considered to occur instantly at the cutting point, since the label mass is negligible with respect to the entity of the tractive forces acting thereupon.

With reference to FIG. 1, glue applicator 15 preferably comprises a glue roller 28 having an axis Z parallel to axes V, W, X, Y and cooperating tangentially with transfer drum 8.

In particular, glue roller 28 is mounted to rotate about its axis Z and has an outer cylindrical lateral surface 29, which is covered by melted glue continuously fed by a glue feeding system, known per se and not shown. In practice, as it is advanced by transfer drum 8, each label 3 contacts, on the opposite side thereof with respect to the transfer drum 8, the glue roller 28 to be spread with glue. In other words, a predetermined glue pattern is applied by the glue roller 28 onto the side of the label 3 destined to contact the surface of the article 4.

As a possible alternative not shown, glue applicator 15 may comprise a spray or an injector system in place of the glue roller 28. The glue pattern may comprise a layer of glue and/or one or more glue strips and/or one or more glue spots.

With reference to FIGS. 1 and 2, apparatus 1 further comprises a cleaning device 30 arranged peripherally with respect to transfer drum 8 and which in turn includes a laser emitter 31, generating in use a laser beam directed transversally towards the transfer drum 8 to remove dirt and/or glue residues from the outer lateral surface 18 of the transfer drum 8 itself, and a fume evacuation hood 32, operating adjacent to the laser emitter 31 to remove the fumes produced by the laser beam during the cleaning action.

In the embodiment shown in FIGS. 1 and 2, laser emitter 31 and fume evacuation hood 32 are defined by distinct bodies; in particular, in this case, the laser emitter 31 has a head 33 at least partially housed within the fume evacuation hood 32.

Laser emitter 31 preferably has a tapered configuration towards the transfer drum 6; in a different manner, fume evacuation hood 32 has a tapered configuration in a direction moving away from the transfer drum 8.

As clearly shown in FIG. 1, laser emitter 31 and fume evacuation hood 32 are both arranged between input station 10 and glue applicator 15 with reference to label path Q.

As possible alternatives not shown, laser emitter 31 and fume evacuation hood 32 may be also arranged;

between the glue applicator 15 and application station 11; or

between application station 11 and cutting unit 14.

With reference to FIG. 1, apparatus 1 further comprises a control unit 35 configured to activate laser emitter 31 and fume evacuation hood 32 according to given operative modes.

In all embodiments shown, control unit 35 is configured to activate laser emitter 31 and fume evacuation hood 32 simultaneously and according to the same operative modes.

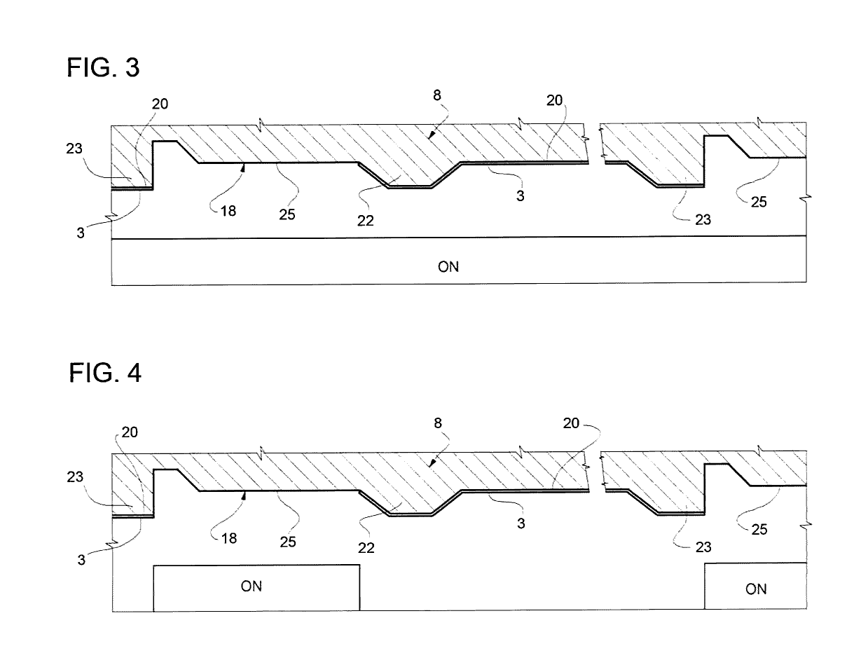

In the example shown in FIG. 3, laser emitter 31 and fume evacuation hood 32 are activated by control unit 35 continuously during rotation of transfer drum 8. This continuous activation of laser emitter 31 has been represented in FIG. 3 by the strip-shaped block carrying therein the wording “ON”.

The applicant has observed, that the laser emitter 31 does not produce any ablation action on the exposed surfaces of the labels 3, i.e. the ones destined to be applied on articles 4, as such surfaces are normally glossy and/or colored white opaque.

In the example shown in FIG. 4, laser emitter 31 and fume evacuation hood 32 are activated by control unit 35 by impulses during rotation of transfer drum 8 so as to direct the laser beam on ail transitions regions 25 of the outer lateral surface 18 during each turn of the transfer drum 8 itself. Even in this case, each impulse activation of laser emitter 31 has been represented in FIG. 4 by a strip-shaped block carrying the wording “ON”. As can be clearly seen in such Figure, the ON-blocks are just in front of respective transition regions 25 of the outer lateral surface 18 of the transfer drum 8.

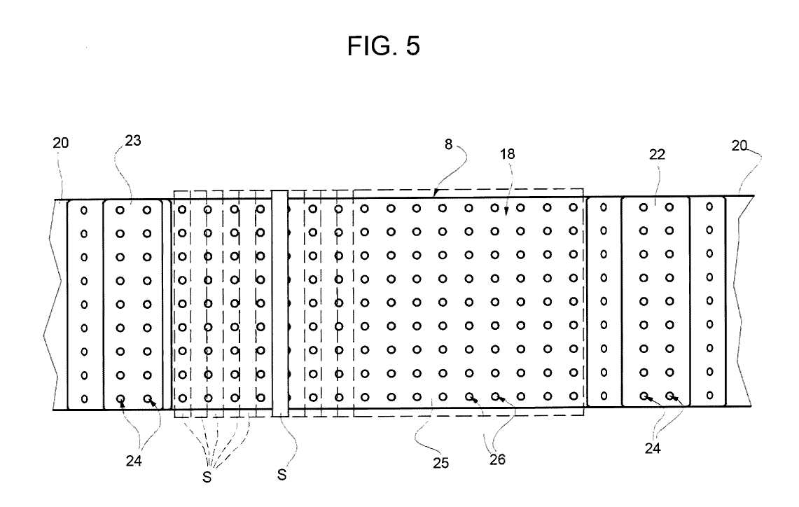

In the further examples of FIGS. 5, 6 and 8, laser emitter 31 and fume evacuation hood 32 are activated by control unit 35 by impulses, but, during each of said impulses, the relative transition region 25 is irradiated at a selected portion S narrower than the transition region 25 itself; in this case, control, unit 35 is configured to cause the laser emitter 31 to irradiate, during each turn of the transfer drum 8 and per each transition region 25, one selected portion S offset with respect to the selected portion S irradiated during the immediately previous turn of the transfer drum 8 itself so as to entirely clean such transition region 25 during a plurality of turns of the transfer drum 8.

In greater details, in the example of FIG. 5, each selected portion S has a strip configuration, extending parallel to axis X of the transfer drum 8; in addition, each selected portion S has, in a direction parallel to axis X, the same height as the relative transition region 25.

Moreover, in the example of FIG. 5, the offset selected portions 8 of the outer lateral surface 18 of the transfer drum 8 irradiated during two consecutive turns of the transfer drum 8 itself are distinct from, and adjacent to, one another, without overlapping areas.

Any change in the laser beam to irradiate differently-located selected portions S during the successive turns of the transfer drum 8 is achieved by appropriately timing the activation of the laser emitter 31 relative to the transfer drum position, e.g. through an encoder and/or transfer drum surface recognition systems—sensors, cameras, etc.

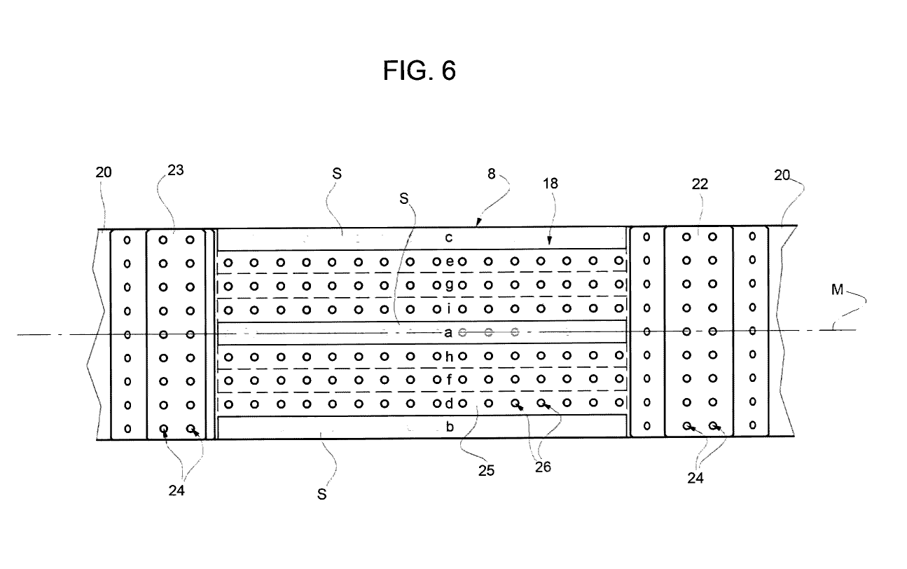

In the example of FIG. 6, each selected portion S has a strip configuration extending parallel to a plane orthogonal to axis X of the transfer drum 8; in addition, each selected portion S has the same width as the relative transition region 25, i.e. extends from the pad 22 to the pad 23 delimiting such transition region 25.

In order to avoid possible misalignments of the labels 3 with respect to their desired positions on the transfer drum 8 during feeding to the latter, cleaning of each transition region 25 is performed symmetrically with respect to an intermediate plane M crossing the transfer drum 8 itself orthogonally to its axis X; this means that, during one turn or two consecutive turns of the transfer drum 8, the selected portion S or the selected portions S of a specific transition region 25 irradiated by the laser beam is or are symmetrically arranged with respect to intermediate plane M.

In this way, the residues of glue remaining on each transition region 25 during the successive turns of the transfer drum 8 cannot produce any undesired inclination of the labels 3 during feeding to the respective retaining region 20.

In the preferred example shown in FIG. 6 with reference to one transition region 25, the cleaning action is performed by laser emitter 31 according to the following order:

the first selected portion S cleaned by the laser beam during the first turn of the transfer drum 8 is the one crossed by the intermediate plane M and designated with letter a;

the second selected portion S cleaned by the laser beam during the second turn of the transfer drum 8 is the one located on one side of intermediate plane M and designated with letter b;

the third selected portion S cleaned by the laser beam, during the third turn of the transfer drum 8 is the one designated with letter c and located symmetrically on the opposite side of intermediate plane M with respect to the selected portion S designated with letter b; and

the following selected portions S cleaned by the laser beam during the successive turns of the transfer arum 8 are the ones designated with letters d, e, f, g, h, i and alternatively located symmetrically on the opposite sides of intermediate plane M.

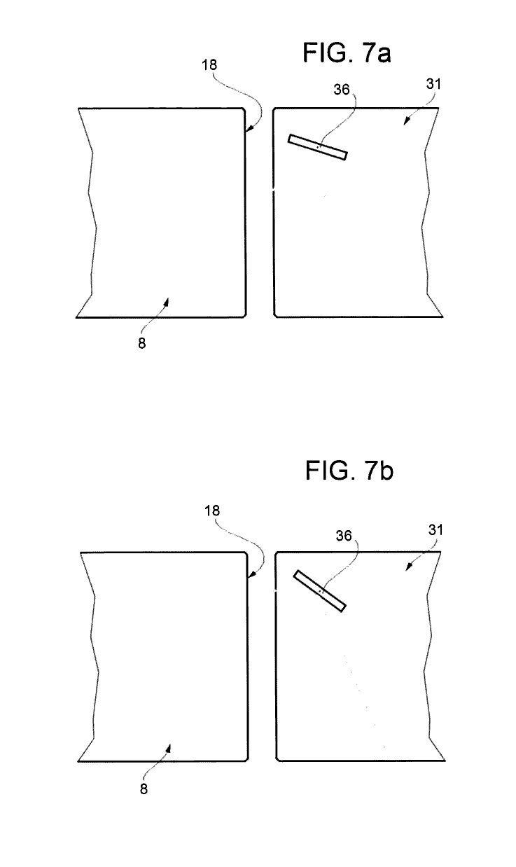

As shown in FIGS. 7a and 7b, any change of orientation of the laser beam to irradiate selected portions S of the transfer drum 8 located at different heights with respect to axis X is obtained by optical deflection of the laser beam itself through one or more movable mirrors 36 carried by laser emitter 31.

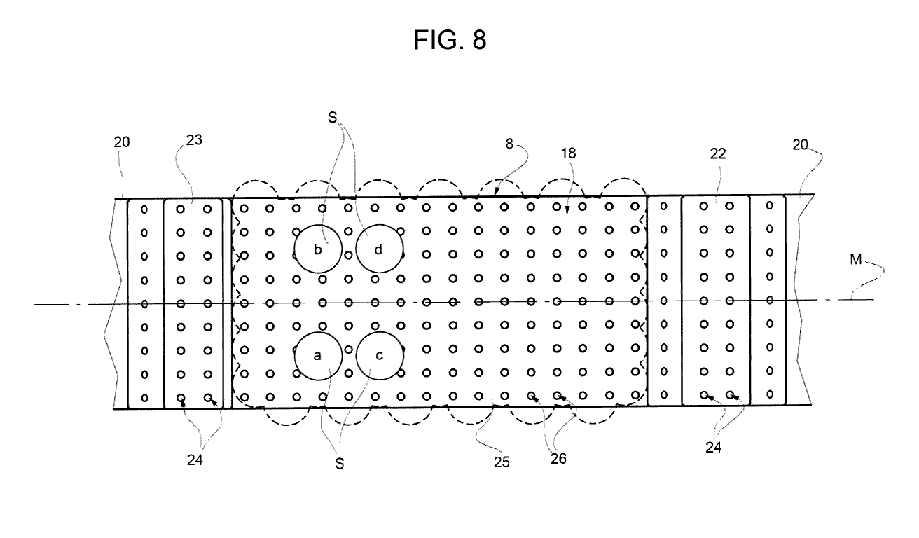

In the example of FIG. 8, each selected portion S has a circular or oval spot configuration. Even in this case, analogously to the example shown in FIG. 6, cleaning of each transition region 25 is performed symmetrically with respect to intermediate plane M, e.g. according to the order represented by letters a to d.

According to a preferred embodiment of the present invention, laser emitter 31 has different power settings; control unit 35 is therefore configured to activate laser emitter 31 at a low power setting during production, and at high power setting during any stop of production with the transfer drum 8 rotating at a lower speed than the speed during production or discontinuously.

The low power setting and the high power setting can range from 0.1 Watt to 1 KW according to the contamination to be removed, which can, in turn, range from non-visible micro-quantities of contamination accumulated during normal production, to blanket coverage some millimeters thick, arising from machine faults.

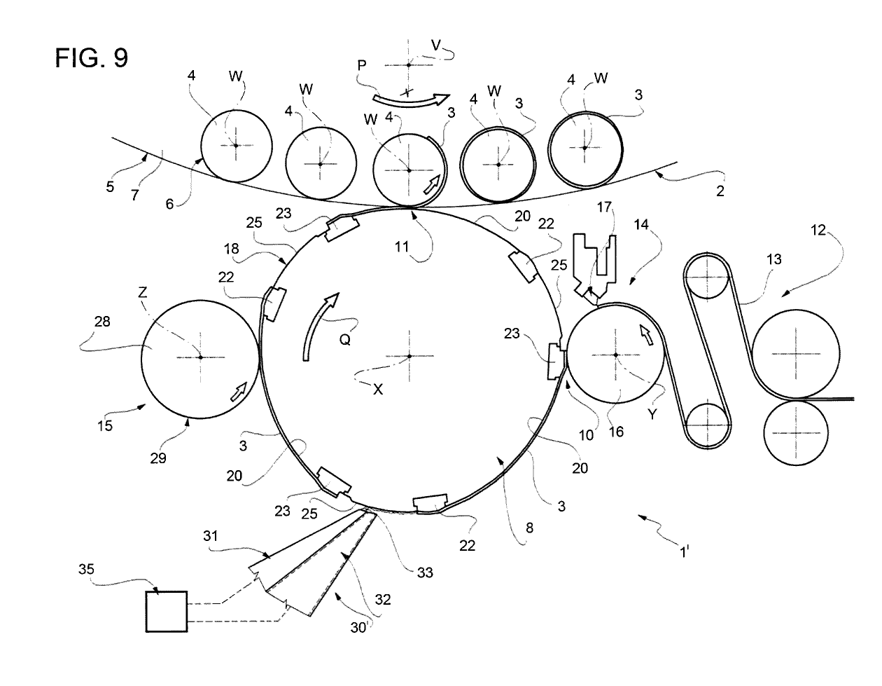

Number 1′ in FIG. 9 indicates as a whole a different embodiment of a label application apparatus for a labelling machine 2; apparatuses 1 and 1′ being similar to one another, the following description is limited to the difference between, them, and using the same references, where possible, for identical or corresponding parts.

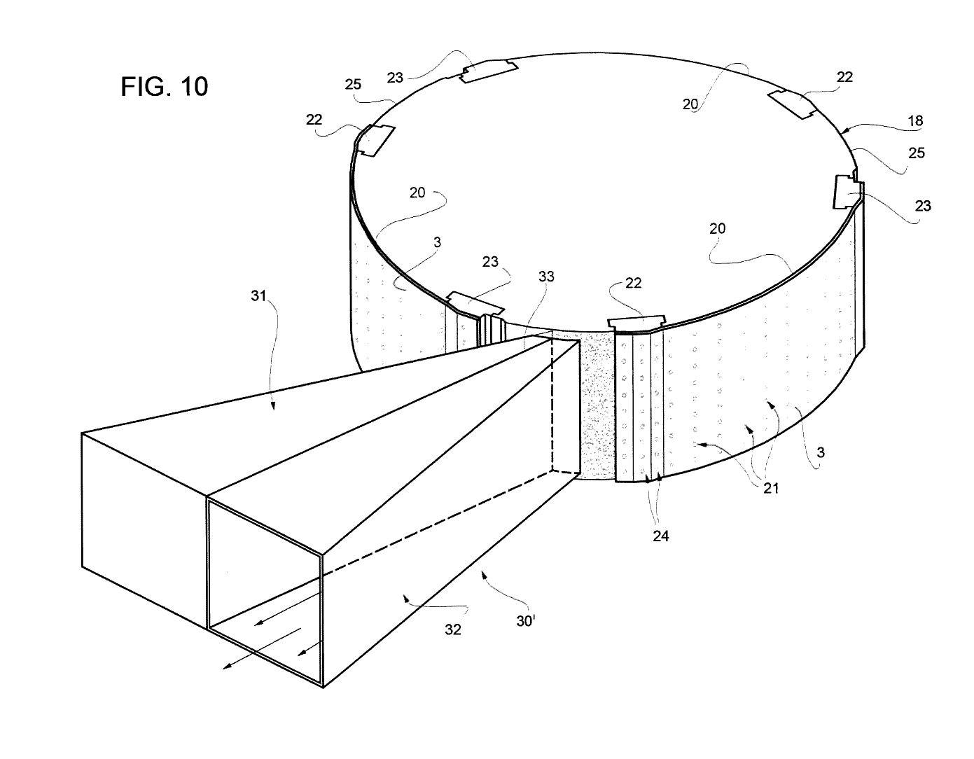

In particular, apparatus lf differs from apparatus 1 by including a different cleaning device 30′ (FIGS. 9 and 10); in particular, cleaning device 30′ differs from, cleaning device 30 only in that laser emitter 31 and fume evacuation hood 32 are integrated in one single body.

In use, labels 3 are fed, one after the other, to transfer drum 8 by feeding unit 12 and then rotated by the transfer drum 8 itself along label path Q from input station 10 to application station 11; in the meantime, articles 4 are advanced along article path P by carrousel 5 so as to receive the respective labels 3 at the application station 11.

In particular, at input station 10, transfer drum 8 continuously rotating about, its axis X, receives the web 13 of labelling material, which is then cut to obtain a label 3 of the desired length by interaction between the rotary cutting drum 16 and the stationary cutter 17. More specifically, the web 13 first advances with the rotary cutting drum 16 while being retained onto the outer lateral surface thereof by suction. The suction is discontinued when the leading edge of the web 13 of labelling material is picked by transfer dram 8.

As it is transferred substantially at the input station 10, the labelling material is subject to a tension created by the simultaneous supply of suction from both the transfer drum 8 and the rotary cutting drum 16. As the transfer progresses, the influence of the suction supplied at the rotary cutting drum 16 decreases, as the portion of labelling material retained by the transfer drum 8 increases. As a consequence, the web 13 comes to engage the stationary cutter 17.

At the cutting point, the cut label 3 is carried solely by the transfer drum 8. The completion of the transfer can be considered to occur instantly at the cutting point, since the label mass is negligible with respect to the entity of the tractive forces acting thereupon.

During transfer from the rotary cutting drum 16 to the transfer drum 8, the labelling material forming each label 3 slides along a relative transition region 25 prior to reaching the subsequent retaining region 20.

Along label path Q, each label 3 is supported by transfer drum 8 along the side destined to define the front surface when the label 3 itself is applied onto the respective article 4.

During rotation of transfer drum 6 about axis X, each label 3 interacts with glue roller 28 for retaining from the latter a layer of melted glue on its back surface opposite the one contacting the transfer drum 8 itself.

Glue roller 2 8 also rotates about its axis 2 in a direction opposite the one of transfer drum 3.

Airborne glue particles and filaments are created when the trailing edge of each label 3 detaches from glue roller 28; air turbulence and movements cause some of these particles and filaments to contact and deposit on the adjacent transition region 25.

During each turn of transfer drum 8, laser emitter 31 and fume evacuation hood 32 remove these deposits from transition regions 25 according to one of the different operative modes described with reference to FIGS. 3 to 8.

In this way it is possible to remove any hindrance to the slipping of the labels 3 during feeding to the transfer drum 8.

The described possible uses of the laser emitter 31 and fume evacuation hood 32 during production require a low energy applied per square centimeter and per second, as the amounts of glue and dirt deposits to be removed from transfer drum 8 are very little.

In addition, by intervening during production, it is possible to achieve 100% autonomy of label application apparatus 1 and labelling machine 2.

During any stop of production, thanks to the fact that laser emitter 31 has different power settings, it is possible to activate the laser emitter 31 itself at a high power setting so as to remove heavier deposits possibly accumulated in any part of transfer drum 8.

Among the different operative modes of laser emitter 31 and fume evacuation hood 32, the ones described with reference to FIGS. 5 to 8 require the lowest energy levels, with consequent very reduced costs and high safety. Plus, the operative modes of FIGS. 5 to 8 can be easily adapted to different formats of labels 3, as they treat very small areas per each tarn of transfer drum 8.

Clearly, changes may be made to label application apparatus 1, 1′ as described and illustrated herein without, however, departing from the scope of protection as defined in the accompanying claims.

For example, the laser emitter 31 may remain deactivated for a predetermined period of time or label production quantity, and then activated for a predetermined period of time or label production quantity, to remove any accumulated contamination, using commensurate power levels.

1. A label application apparatus comprising:
an input station, at which a succession of separate labels is formed;
an application station, at which each of the labels is applied on a respective article advancing along an article path;
a transfer drum configured to retain each label on an outer lateral surface of the transfer drum by suction and to rotate about an axis to transfer each of the labels from the input station to the application station along a label path tangential to the article path at the application station;
a glue applicator arranged peripherally with respect to the transfer drum between the input and application stations with reference to the label path, the glue applicator being configured to apply a given amount of glue on the back side of each label advancing along the label path prior to reaching the application station; and
a laser emitter arranged peripherally with respect to the transfer drum and configured to generate a laser beam towards the transfer drum to remove at least one of dirt or glue residues from the outer lateral surface of the transfer drum.

2. The apparatus of claim 1, further comprising a fume evacuation device operating adjacent to the laser emitter and configured to remove the fumes produced by the laser beam during cleaning of the at least one of dirt or glue residues from the outer lateral surface of the transfer drum.

3. The apparatus of claim 2, wherein the laser emitter and the evacuation device are incorporated in one single body.

4. The apparatus of claim 1, wherein the laser emitter is arranged between the input station and the glue applicator with reference to the label path.

5. The apparatus of claim 1, wherein the laser beam is directed transversally to the outer lateral surface of the transfer drum.

6. The apparatus of claim 1, wherein the outer lateral surface of the transfer drum includes:
at least one label retaining region, on which a relative label is retained during transfer from the input station to the application station, and
at least one transition region on which a relative label fed to the transfer drum slides prior to reaching the at least one label retaining region.

7. The apparatus of claim 6, further comprising a control unit in communication with the laser emitter and configured to activate the laser emitter continuously during rotation of the transfer drum.

8. The apparatus of claim 6, further comprising a control unit in communication with the laser emitter and configured to activate the laser emitter by impulses during rotation of the transfer drum so as to direct the laser beam on at least one selected portion of the outer lateral surface of the transfer drum during each of a plurality of turns of the transfer drum itself.

9. The apparatus of claim 8, wherein the at least one selected portion is narrower than the at least one transition region, and wherein the control unit is configured to cause the laser emitter to irradiate, during each turn of the plurality of turns of the transfer drum, one selected portion offset with respect to the another selected portion irradiated during the immediately previous turn of the transfer drum so as to clean the entire at least one transition region during the plurality of turns of the transfer drum.

10. The apparatus of claim 9, wherein the at least one selected portion has a strip configuration extending parallel to the axis of the transfer drum.

11. The apparatus of claim 10, wherein the at least one selected portion has, in a direction parallel to the axis, the same height as the at least one transition region.

12. The apparatus of claim 9, wherein the at least one selected portion has a strip configuration extending parallel to a plane orthogonal to the axis.

13. The apparatus of claim 9, wherein offset selected portions of the outer lateral surface of the transfer drum irradiated during two consecutive turns of the transfer drum are distinct from one another without overlapping areas.

14. The apparatus of claim 9, wherein said the at least one selected portion has a spot configuration.

15. The apparatus of claim 12, wherein, during one turn or two consecutive turns of the transfer drum, the at least one selected portion irradiated by the laser beam is symmetrically arranged with respect to an intermediate plane crossing the transfer drum orthogonally to the axis.

16. The apparatus of claim 6, wherein the outer lateral surface of the transfer drum includes at least two label retaining regions and at least two transition regions, each of the at least two transition regions being interposed between the at least two label retaining regions.

17. The apparatus of claim 7, further comprising a fume evacuation device operating adjacent to the laser emitter and configured to remove the fumes produced by the laser beam during cleaning of the at least one of dirt or glue residues from the outer lateral surface of the transfer drum, wherein the control unit is configured to activate the fume evacuation device simultaneously with the laser emitter and according to the same operative mode.

18. The apparatus of claim 7, wherein the laser emitter has different power settings, and wherein the control unit is configured to activate the laser emitter at a first power setting during production that is lower than a second power setting during any stop of production with the transfer drum rotating at a speed that is lower than a speed during production or rotating discontinuously.
